(19) United States
(12) Patent Application Publication
(10) Pub. No.: US 2024/0201474 A1
(43) Pub. Date: Jun. 20, 2024

(54) Projection Device

(71) Applicant: Shenzhen Oceanwing Smart Innovations Technology Co., Ltd, Shenzhen (CN)

(72) Inventor: Zhou Xu, Shenzhen (CN)

(21) Appl. No.: 18/555,054

(22) PCT Filed: Apr. 14, 2022
(86) PCT No.: PCT/CN22/86915

§ 371 Date: Oct. 12, 2023

(30) Foreign Application Priority Data
Apr. 14, 2021 (CN) 202110400520.1
Apr. 14, 2021 (CN) 202120770046.7

(51) Int. Cl. G02B 13/16; G03B 21/20

(52) U.S. Cl. CPC G02B 13/16; G03B 21/2066

(57) ABSTRACT

This application relates to the field of projection device technology, and discloses a projection device, a projection lens component, and a projection system. The projection device comprises a display device, which has a display surface that is a curved surface, where the curvature of the display surface matches the curvature of the projection surface of the projection screen; The projection device also comprises a projection lens component, the incident light surface of the projection lens component is a plane and/or a convex arc surface towards the display surface, the light beam output from the display surface enters the projection lens component from the incident light surface and then is projected to the projection surface through the projection lens component. In this way, this application can improve the projection effect.

### FIELD

The present application relates to the field of projection technology, especially a projection device, projection lens assembly, and projection system.

### BACKGROUND

Currently, projection devices on the market usually use flat display devices as image sources. The clear image projected by the flat display device through the projection lens is a flat image. If the projection device is used in conjunction with a curved projection screen, due to the aberration in the design of the projection lens, when the flat display device projects an image on the curved projection screen through the projection lens, it may cause the middle and sides of the image projected on the curved projection screen to form a focus deviation. This means that the middle and sides of the image on the curved projection screen cannot be clearly imaged at the same time, the projection effect is poor, greatly reducing the viewer's experience.

### SUMMARY

In view of this, the technical problem mainly solved by this application is to provide a projection device, a projection lens assembly, and a projection system that can improve the projection effect.

To solve the above technical problem, one technical solution adopted by this application is to provide a projection device. The projection device comprises a display device, the display device has a display surface, the display surface is a curved surface, where the curvature of the display surface matches the curvature of the projection surface of the projection screen; the projection device also comprises a projection lens assembly, the light entrance surface of the projection lens assembly is a flat surface and/or a curved surface protruding towards the display surface, the light beam output from the display surface enters the projection lens assembly from the light entrance surface and then is projected to the projection surface through the projection lens assembly.

In one example of this application, the display device comprises a first display device, a second display device, and a third display device, the first display device, the second display device, and the third display device can output images of different colors respectively; the projection lens assembly comprises a first lens to a third lens, the first lens to the third lens are sequentially arranged along a circumferential direction, the first lens to the third lens each have a light entrance surface, the light entrance surfaces of the first lens to the third lens are respectively correspondingly set with the display surfaces of the first display device to the third display device.

In one example of this application, a first film layer is provided on the surface between the first lens and the second lens and on the surface of the third lens away from the second lens, the first film layer can reflect the light beam output by the first display device and can transmit the light beam output by the second display device and the third display device; a second film layer is provided on the surface between the second lens and the third lens and on the surface of the first lens away from the second lens, the second film layer can reflect the light beam output by the third display device and can transmit the light beam output by the first display device and the second display device.

In one example of this application, the curvature of the display surface of the first display device, the curvature of the display surface of the second display device, and the curvature of the display surface of the third display device are equal.

In one example of this application, the second side surface of the first lens is a curved surface convex towards the first display device; the second side surface of the second lens is a curved surface convex towards the second display device; the second side surface of the third lens is a curved surface convex towards the third display device.

In one example of this application, the curvature of the second side surface of the first lens is equal to the curvature of the display surface of the first display device; the curvature of the second side surface of the second lens is equal to the curvature of the display surface of the second display device; the curvature of the second side surface of the third lens is equal to the curvature of the display surface of the third display device.

In one example of this application, the light entrance surfaces of the first lens to the third lens are all flat surfaces.

In one example of this application, the first display device and the first lens are spaced apart from each other, the second display device and the second lens are spaced apart from each other, and the third display device and the third lens are spaced apart from each other to form an adjustment gap.

In one example of this application, the projection lens assembly also comprises a light-adjusting lens group, the first lens to the third lens and the light-adjusting lens group are sequentially arranged in a circumferential direction, and the light beams incident on the first lens to the third lens are all emitted from the light-adjusting lens group.

In one example of this application, the light-adjusting lens group comprises a plurality of light-adjusting lenses, the plurality of light-adjusting lenses are sequentially arranged in the direction of light beam propagation, or the light-adjusting lens group comprises a curved mirror, the curved mirror protrudes towards the direction of light beam propagation.

To solve the above technical problem, another technical solution adopted by this application is to provide a projection lens assembly, which is applied to the projection device as described in the above example; the projection lens assembly comprises a color-combining lens group and a light-adjusting lens group, the light beam integrated by the color-combining lens group is incident on the light-adjusting lens group, and then is emitted from the light-adjusting lens group.

To solve the above technical problem, another technical solution adopted by this application is to provide a projection system. The projection system comprises the projection device and the projection screen as described in the above example, the projection screen has a projection surface, and the light beam output by the display device of the projection device is projected onto the projection surface through the projection lens assembly.

The beneficial effect of this application comprises: different from the prior art, this application provides a projection device, a projection lens assembly, and a projection system. The display surface of the display device of the projection device is a curved surface, that is, the clear image projected by the display device through the projection lens assembly is a curved image. And when the projection surface of the projection screen is also a curved surface, the curvature of the display surface matches the curvature of the projection surface, so that the curvature of the clear image projected by the display device matches the curvature of the projection surface, thereby making the clear image projected by the display device can be displayed as completely as possible on the projection surface. That is to say, the middle and sides of the projection surface can focus clearly at the same time, the middle and sides of the image projected on the projection surface can be clearly imaged, that is, the image projected on the projection surface is clearer and the overall clarity is more consistent, which can improve the projection effect and is beneficial to improve the viewer's experience.

### BRIEF DESCRIPTION OF THE DRAWINGS

The accompanying drawings are incorporated into and form a part of this specification, showing examples in accordance with the present application, and together with the description serve to explain the principles of the present application. Moreover, these drawings and the written description are not intended to limit the scope of the concepts of the present application in any way, but rather to illustrate the concepts of the present application to those skilled in the art through reference to specific example.

FIG. 1 shows a schematic diagram of the structure of an example of a curved projection display system in the prior art;

FIG. 2 shows a schematic diagram of the structure of an example of the projection device of the present application;

FIG. 3 shows a schematic diagram of the structure of an example of the projection system of the present application;

FIG. 4 shows a schematic diagram of the structure of an example of the display device and color-combining lens assembly of the present application;

FIG. 5 shows a schematic diagram of the structure of an example of the prism body of the present application;

FIG. 6 shows a schematic diagram of the structure of the color-combining lens assembly shown in FIG. 4 from another perspective;

FIG. 7 shows a schematic diagram of the light path of the display device and color-combining lens assembly shown in FIG. 4;

FIG. 8 shows a schematic diagram of the structure of an example of the first display device and the first lens of the present application;

FIG. 9 shows a schematic diagram of the structure of another example of the first display device and the first lens of the present application;

FIG. 10 shows a schematic diagram of the structure of another example of the projection device of the present application;

FIG. 11 shows a schematic diagram of the structure of an example of the projection lens assembly of the present application;

FIG. 12 shows a schematic diagram of the structure of another example of the projection system of the present application.

### DETAILED DESCRIPTION

In order to make the objectives, technical solutions, and advantages of the present application more clear, the following will describe the technical solutions example of the present application clearly and completely in conjunction with the example of the present application. Obviously, the described example are part of the present application, not all of the examples. Based on the examples in the present application, all other examples obtained by those of ordinary skill in the art without making creative work fall within the protection scope of the present application. In the absence of conflict, the features in the following examples and the examples can be combined with each other.

To solve the technical problem in the prior art that the clarity consistency of the image projected on the curved projection screen by the projection device is poor, example the present application provides a projection device. The projection device comprises a display device. The display device has a display surface, and the display surface is a curved surface, where the curvature of the display surface matches the curvature of the projection surface of the projection screen. The projection device also comprises a projection lens assembly, the light entrance surface of the projection lens assembly is a flat surface and/or a curved surface protruding towards the display surface, the light beam output from the display surface enters the projection lens assembly from the light entrance surface and then is projected to the projection surface through the projection lens assembly. The following is a detailed explanation.

With the introduction of curved TVs, curved display systems have been widely sought after in recent years. Its advantage is that it gives viewers a sense of immersion and envelopment when watching at large sizes and close distances. However, due to the size limitation of curved TVs, most TVs are currently under 85 inches, and most curved TVs are concentrated around 55 inches, resulting in the current size of curved TVs being small, and they cannot provide viewers with enough immersion and envelopment. This has also led to a downward trend in the popularity of curved TVs. However, large-size curved projection display systems used in entertainment venues such as large cinemas and amusement parks can truly give viewers an immersive experience, which is currently a better curved display system. Under the trend of continuous increase in screen size, the curved display system will still be a better differentiated display solution.

For the above-mentioned curved projection display system, the projection device currently used usually uses a flat display device, and it is well known that the clear image projected by the flat display device through the projection lens is also a flat image. As shown in FIG. 1, the clear image A projected by the flat display device 11 through the projection lens 12 is a flat image. Due to the aberration in the design of the projection lens, the middle and sides of the image projected on the curved projection screen form a focus deviation, meaning that the middle and sides of the image on the curved projection screen cannot be clearly imaged at the same time. Referring to FIG. 1 again, the actual image B projected by the flat display device 11 on the curved projection screen 13 is a curved image, where the middle of the actual image B can be clearly imaged, but the sides cannot be clearly imaged. That is to say, the flat display device currently equipped with the curved projection display system may cause poor consistency of projection imaging clarity, which has a negative impact on the viewer's experience.

In view of this, an example of the present application provides a projection device that can improve the consistency of projection imaging clarity, that is, it can improve the projection effect, and thus is beneficial to improve the user's viewing experience.

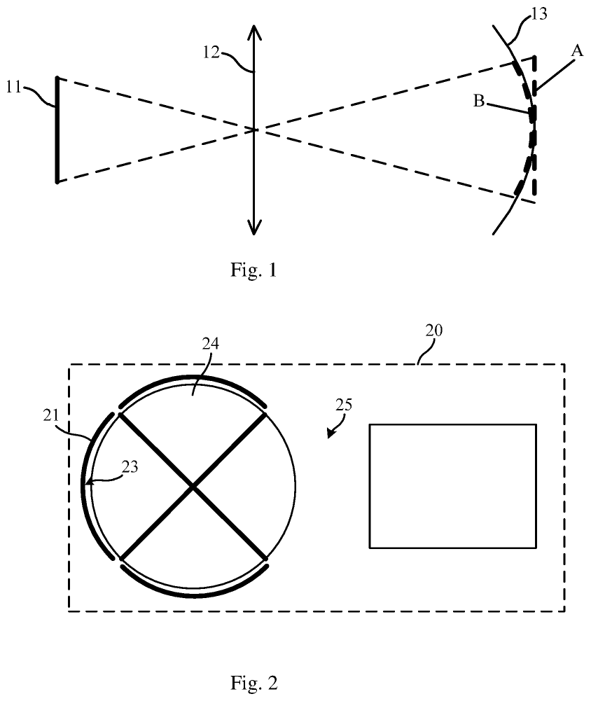

Please refer to FIG. 2, which shows a schematic diagram of the structure of an example of the projection device of the present application.

In one example, the projection device 20 comprises a display device 21 and a projection lens assembly, which are set relative to each other. The display device 21 has a display surface 23, which can emit light and form an image. The projection lens assembly is used to project the image output from the display surface 23 to the projection surface of the projection screen. Through the reasonable design of the projection lens assembly, the overall optical performance and light effect of the projection device 20 can be improved.

The display device 21 can adopt LCD (Liquid Crystal Display), LCOS (Liquid Crystal on Silicon), DLP (Digital Light Processing), OLED (Organic Light-Emitting Diode), MEMS (Micro-Electro-Mechanical System), Micro-LED (Micro-Light Emitting Diode) and/or other display technologies. The display device 21 may determine the main parameters such as brightness, contrast, resolution, and color gamut of the entire projection device 20. The above-mentioned LCD, LCOS, DLP, MEMS and other display technologies are mainly applied to flat display devices, while OLED and Micro-LED can be designed as flexible devices to achieve curved display. Among them, Micro-LED display technology has high brightness, which can reach tens of thousands of nits or higher, and Micro-LED display technology can have a higher pixel density design, the size of its semiconductor light-emitting diode can be as small as the micron level, PPI (Pixels Per Inch, pixel density) can be greater than 5000, and the contrast can also reach 100000:1 or more, in addition, Micro-LED display technology has a wide color gamut, fast response speed, and can work at temperatures from −70° C. to 100° C., and has a long service life. Therefore, as an example, the display device 21 adopts Micro-LED display technology.

In other examples of this application, the display device 21 can adopt other display technologies besides Micro-LED display technology, such as LCD, LCOS, DLP, MEMS, etc. mentioned above. Moreover, the display device 21 can be flexible itself, and the display surface 23 on it can be curved into a curved surface through its own bending action. Of course, it can also be that the display device 21 itself does not have flexibility, but its display surface 23 is directly designed as a curved surface.

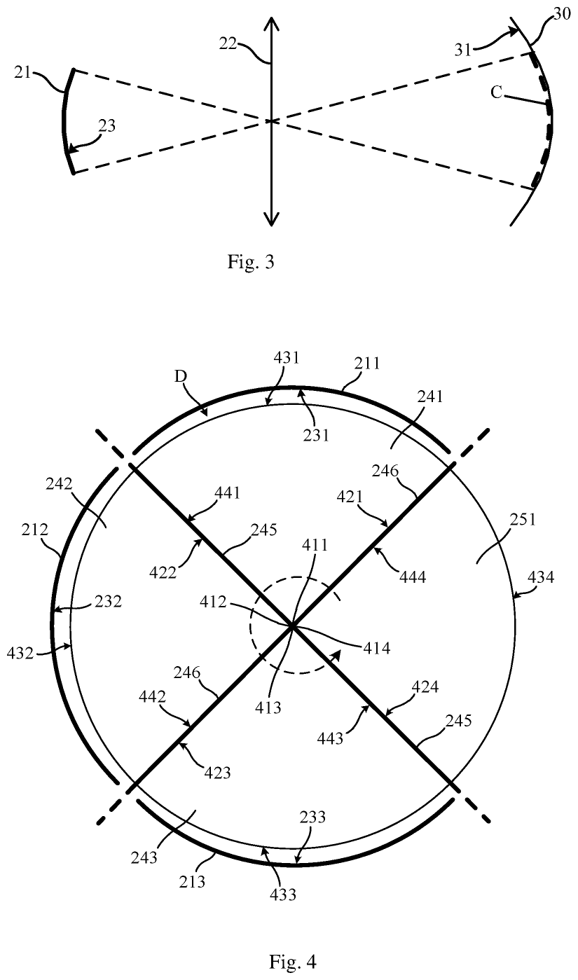

Please also refer to FIG. 3, which shows a schematic diagram of the structure of an example of the projection system of this application.

The projection device 20 can be applied to the above-mentioned curved projection display system, that is, the projection screen 30 has a projection surface 31 (e.g., projector screen), and the projection surface 31 is a curved surface. Further, the projection surface 31 may be concave towards the incident light. In other words, the projection surface 31 may be concave along the propagation direction of the light beam it receives. To match the curved imaging requirements of the projection surface 31, the display surface 23 of the display device 21 in this example may be also a curved surface. In other words, the display surface 23 of the display device 21 may be set in a curved shape. Because the clear image C projected by the curved display surface 23 through the projection lens assembly is a curved image, the clear image C projected by the display device 21 can be displayed as completely as possible on the projection surface 31, which is also a curved surface, as shown in FIG. 3. That is to say, the middle and sides of the projection surface 31 can be clearly focused as much as possible, and the middle and sides of the image projected on the projection surface 31 can be clearly imaged as much as possible, that is, the image projected on the projection surface 31 is clearer and the overall clarity is more consistent, which can avoid the phenomenon of defocus or virtual focus as much as possible, thereby improving the projection effect and improving the viewer's experience.

Because the display surface 23 of the display device 21 is set in a curved shape, it can surround a part of the outer periphery of the light entrance surface of the projection lens assembly. The projection lens assembly is used to guide the light beam emitted from the display surface 23 from the part of the outer periphery of the light entrance surface that is surrounded to another part of the outer periphery of the light entrance surface that is away from the display surface 23 and is not surrounded, and then project it onto the projection surface 31. In this way, by setting the curved display surface 23 to surround a part of the outer periphery of the projection lens assembly, the light beam can be shot from another part of the outer periphery that is not surrounded to the curved projection surface 31, so that the light beam can be more effectively projected onto the projection surface 31, thereby making the image on the projection surface 31 clearer and the overall clarity more consistent, avoiding the phenomenon of defocus or virtual focus as much as possible, thereby improving the projection effect and improving the viewer's experience.

And, the curvature of the display surface 23 may match the curvature of the projection surface 31, meaning that the curvature of the display surface 23 may be the same or close to the curvature of the projection surface 31. In this way, the curvature of the clear image C projected by the display device 21 matches the curvature of the projection surface 31, further ensuring that the clear image C projected by the display device 21 is completely displayed on the projection surface 31, as shown in FIG. 3, to further ensure that the middle and sides of the projection surface 31 can be focused clearly at the same time, and further ensure that the middle and sides of the image projected on the projection surface 31 can be imaged as clearly as possible, thereby making the clarity consistency of the image projected on the projection surface 31 further improved, which can further improve the projection effect and is further beneficial to improve the user's viewing experience.

Please refer to FIGS. 2 and 4, FIG. 4 shows a schematic diagram of the structure of an example of the display device and color combining lens group of this application.

In one example, the display device 21 comprises a first display device 211, a second display device 212, and a third display device 213. The first display device 211, the second display device 212, and the third display device 213 can each output light beams of different colors. The projection lens assembly comprises a color combining lens group 24, which is used to integrate the light beams output by the first display device 211, the second display device 212, and the third display device 213 and project them onto the projection screen.

Optionally, the first display device 211, the second display device 212, and the third display device 213 can output three primary color light beams. For example, the first display device 211 can output a red light beam, the second display device 212 can output a green light beam, and the third display device 213 can output a blue light beam. The light beams output by the first display device 211, the second display device 212, and the third display device 213 are integrated through the color combining lens group 24.

It should be noted that the images output by the first display device 211, the second display device 212, and the third display device 213 may only differ in color, and the content contained in the images output by the three is consistent.

In other examples of this application, the first display device 211, the second display device 212, and the third display device 213 are not limited to only outputting three primary color images, the colors of the images output by the first display device 211, the second display device 212, and the third display device 213 can form an image that meets the requirements after being integrated by the color combining lens group 24, and are not limited here.

In view of the design of the display surface 23 of the display device 21 in the above example being a curved surface, the display surfaces 231 of the first display device 211, 232 of the second display device 212, and 233 of the third display device 213 in this example all face the color combining lens group 24, so that the light beams output by the first display device 211, the second display device 212, and the third display device 213 can be projected to the projection lens assembly through the color combining lens group 24. And, the display surfaces 231 of the first display device 211, 232 of the second display device 212, and 233 of the third display device 213 all recess in the direction away from the color combining lens group 24.

Furthermore, the curvature of the display surface 231 of the first display device 211, the curvature of the display surface 232 of the second display device 212, and the curvature of the display surface 233 of the third display device 213 may be equal. In this way, it is conducive to ensuring that the light beams output by the first display device 211, the second display device 212, and the third display device 213 have good consistency after being integrated by the color combining lens group 24, which is further conducive to improving the projection effect.

Please continue to refer to FIGS. 2, 4 and 5, FIG. 5 shows a schematic diagram of the structure of an example of the prism body of this application.

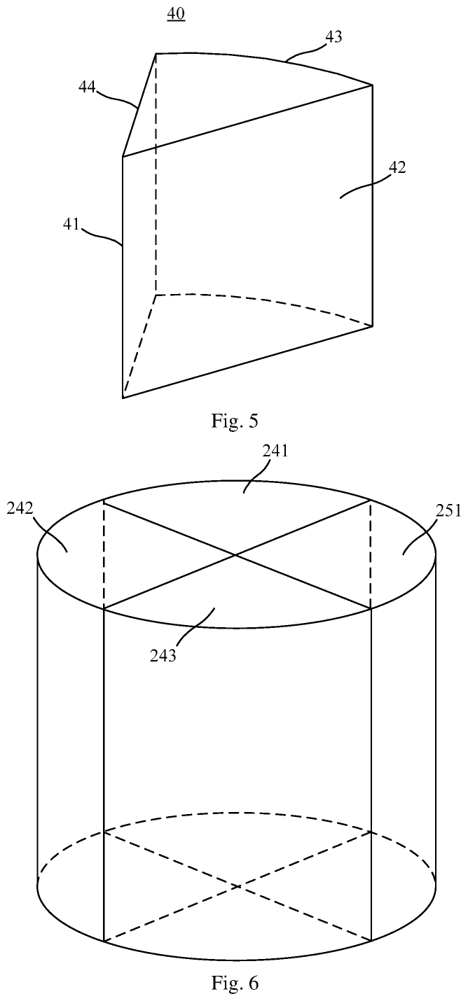

In one example, the color combining lens group 24 comprises a first lens 241, a second lens 242, and a third lens 243. The first lens 241, the second lens 242, and the third lens 243 may all be prisms 40. The side of the prism 40 comprises a first side 42, an incident light surface 43, and a second side 44 connected in sequence, with the edges of the first side 42 and the second side 44 far from the incident light surface 43 connected, where the edge connecting the first side 42 and the second side 44 is their common edge, which is the target edge 41, as shown in FIG. 5. Optionally, the first lens 241, the second lens 242, and the third lens 243 can be set in the shape of a fan-shaped column, and the incident light surfaces of the first lens 241, the second lens 242, and the third lens 243 can be set in an arc shape. As shown in FIG. 4, the first lens 241, the second lens 242, and the third lens 243 are arranged in sequence along a circumferential direction (as shown by the dashed arrow in FIG. 4, the same below). And, the target edges 411 of the first lens 241, 412 of the second lens 242, and 413 of the third lens 243 abut each other, so that the target edges 411 of the first lens 241, 412 of the second lens 242, and 413 of the third lens 243 overlap. For example, taking the first side and the second side of the above-mentioned prism set in sequence along the circumferential direction as an example, the second side 441 of the first lens 241 and the first side 422 of the second lens 242 are close to each other, and the second side 442 of the second lens 242 and the first side 423 of the third lens 243 are close to each other. Optionally, the first lens 241, the second lens 242, and the third lens 243 can be spliced together to form at least part of a cylinder.

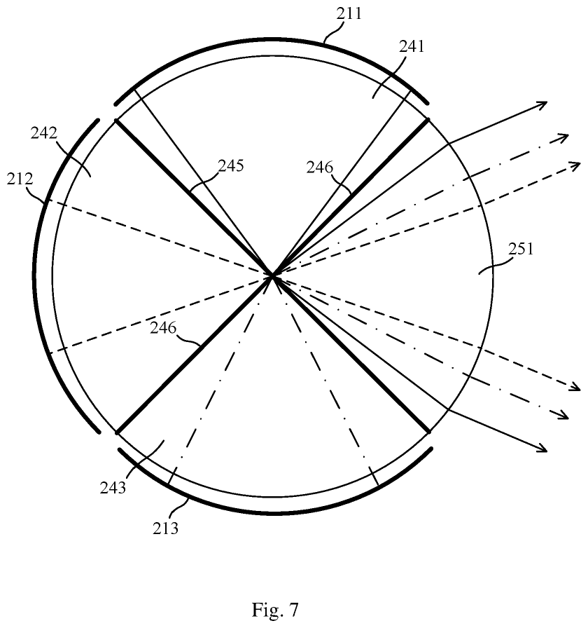

Furthermore, the heights of the first lens 241, the second lens 242, and the third lens 243 are the same, the top surfaces of the first lens 241, the second lens 242, and the third lens 243 are on the same plane, and their bottom surfaces are also on the same plane, as shown in FIG. 6. FIG. 4 shows the top view of the color combining lens group shown in FIG. 6.

Please refer to FIG. 4, each of the first lens 241, the second lens 242, and the third lens 243 has a light entrance surface, the light entrance surfaces of the first lens 241, the second lens 242, and the third lens 243 are respectively set in correspondence with the display surfaces of the first display device 211, the second lens 242, and the third display device 213.

Specifically, the display surface 231 of the first display device 211 faces the light entrance surface 431 of the first lens 241, so that the light beam output by the first display device 211 enters the first lens 241 through the light entrance surface 431 of the first lens 241; the display surface 232 of the second display device 212 faces the light entrance surface 432 of the second lens 242, so that the light beam output by the second display device 212 enters the second lens 242 through the light entrance surface 432 of the second lens 242; the display surface 233 of the third display device 213 faces the light entrance surface 433 of the third lens 243, so that the light beam output by the third display device 213 enters the third lens 243 through the light entrance surface 433 of the third lens 243.

A first film layer 245 is provided on the surface between the first lens 241 and the second lens 242 and on the surface of the third lens 243 away from the second lens 242. The first film layer 245 can reflect the light beam output by the first display device 211 and can transmit the light beam output by the second display device 212 and the third display device 213. After the light beam output by the first display device 211 is incident on the first lens 241, it is reflected by the first film layer 245 and then propagates towards the side of the first lens 241 and the third lens 243 away from the second lens 242, and exits from the side of the first lens 241 and the third lens 243 away from the second lens 242, as shown in FIG. 7; and after the light beam output by the second display device 212 is incident on the second lens 242, it passes through the first film layer 245 and exits from the side of the first lens 241 and the third lens 243 away from the second lens 242, as shown in FIG. 7.

A second film layer 246 is provided on the surface between the second lens 242 and the third lens 243 and on the surface of the first lens 241 away from the second lens 242. The second film layer 246 can reflect the light beam output by the third display device 213 and can transmit the light beam output by the first display device 211 and the second display device 212. After the light beam output by the third display device 213 is incident on the third lens 243, it is reflected by the second film layer 246 and then propagates towards the side of the first lens 241 and the third lens 243 away from the second lens 242, and exits from the side of the first lens 241 and the third lens 243 away from the second lens 242, as shown in FIG. 7; and after the light beam output by the second display device 212 is incident on the second lens 242, it passes through the second lens 242 and the second film layer 246 and exits from the side of the first lens 241 and the third lens 243 away from the second lens 242, as shown in FIG. 7.

Please refer to FIG. 7, the reason why the first film layer 245 transmits the light beam output by the third display device 213 is: firstly, to allow the light beam output by the third display device 213 to pass through the first film layer 245 to reach the second film layer 246, specifically to allow the light beam output by the third display device 213 to pass through the first film layer 245 on the surface of the third lens 243 away from the second lens 242; secondly, to allow the light beam output by the third display device 213 to reach the side of the first lens 241 and the third lens 243 away from the second lens 242 and exit after being reflected by the second film layer 246, specifically, the light beam output by the third display device 213 can pass through the first film layer 245 on the surface of the third lens 243 away from the second lens 242 after being reflected by the second film layer 246 between the second lens 242 and the third lens 243.

The reason why the second film layer 246 transmits the light beam output by the first display device 211 is: firstly, to allow the light beam output by the first display device 211 to pass through the second film layer 246 to reach the first film layer 245, specifically to allow the light beam output by the first display device 211 to pass through the second film layer 246 on the surface of the first lens 241 away from the second lens 242; secondly, to allow the light beam output by the first display device 211 to reach the side of the first lens 241 and the third lens 243 away from the second lens 242 and exit after being reflected by the first film layer 245, specifically, the light beam output by the first display device 211 can pass through the second film layer 246 on the surface of the first lens 241 away from the second lens 242 after being reflected by the first film layer 245 between the first lens 241 and the second lens 242.

Through the above method, the light rays output by the first display device 211, the second display device 212, and the third display device 213 are incident on the first lens 241, the second lens 242, and the third lens 243, and then pass through the first lens 241, the second lens 242, and the third lens 243, and converge on the side of the first lens 241 and the third lens 243 away from the second lens 242, so that the light rays output by the first display device 211, the second display device 212, and the third display device 213 are integrated together and projected onto the projection screen.

Based on the example that the first display device 211 can output a red light beam, the second display device 212 can output a green light beam, and the third display device 213 can output a blue light beam, the first film layer 245 can reflect red light and allow green light and blue light to pass through, and the second film layer 246 can reflect blue light and allow red light and green light to pass through.

Optionally, the first film layer 245 can be a red light reflecting film, which can reflect red light and allow green light and blue light to pass through; the second film layer 246 can be a blue light reflecting film, which can reflect blue light and allow red light and green light to pass through. The specific material components of the red light reflecting film and the blue light reflecting film are within the understanding of those skilled in the art, and will not be further described here.

Please refer to FIG. 4. In one example, the light entrance surface 431 of the first lens 241 is a curved surface convex towards the first display device 211, so that the light entrance surface 431 of the first lens 241 matches the curvature of the display surface 231 of the first display device 211 as much as possible.

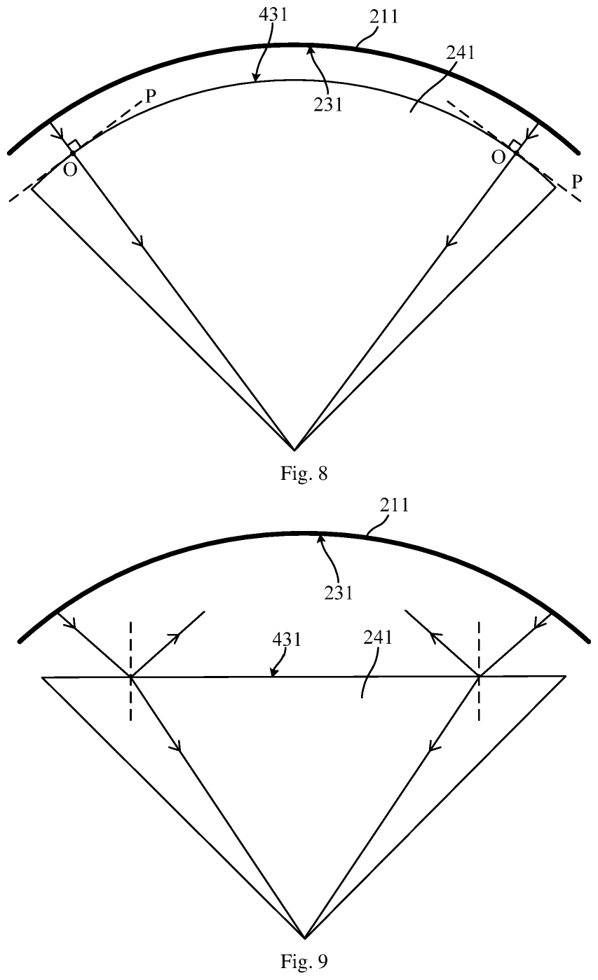

The curvature of the light entrance surface 431 of the first lens 241 matches the curvature of the display surface 231 of the first display device 211, meaning that the curvature of the light entrance surface 431 of the first lens 241 is the same or close to the curvature of the display surface 231 of the first display device 211. For example, as shown in FIG. 8, the curvature of the light entrance surface 431 of the first lens 241 is the same as the curvature of the display surface 231 of the first display device 211. When the light beams output from various positions on the display surface 231 of the first display device 211 are transmitted to the light entrance surface 431 of the first lens 241, the light beams output from the display surface 231 are incident on the first lens 241 perpendicular to the tangent plane P at the incident point O on the light entrance surface 431 (i.e., the light beams output from the display surface 231 propagate along the theoretical light path), to avoid as much as possible reflection and refraction of the light beams when entering the first lens 241, to avoid loss of light quantity and deviation of the actual light path from the theoretical light path, which is beneficial to improve the projection effect.

Similarly, the light entrance surface 432 of the second lens 242 is a curved surface convex towards the second display device 212, so that the light entrance surface 432 of the second lens 242 matches the curvature of the display surface 232 of the second display device 212 as much as possible, to avoid as much as possible reflection and refraction of the light beam output by the second display device 212 when entering the second lens 242, which is further beneficial to improve the projection effect.

Similarly, the light entrance surface 433 of the third lens 243 is a curved surface convex towards the third display device 213, so that the light entrance surface 433 of the third lens 243 matches the curvature of the display surface 233 of the third display device 213 as much as possible, to avoid as much as possible reflection and refraction of the light beam output by the third display device 213 when entering the third lens 243, which is further beneficial to improve the projection effect.

Further, the curvature of the light entrance surface 431 of the first lens 241 is equal to the curvature of the display surface 231 of the first display device 211. In this way, it can be ensured to the maximum extent that the light beam output by the first display device 211 is incident on the first lens 241 along the normal line, and the reflection and refraction of the light beam output by the first display device 211 when entering the first lens 241 are avoided to the maximum extent, which is further conducive to improving the projection effect.

The curvature of the light entrance surface 432 of the second lens 242 is equal to the curvature of the display surface 232 of the second display device 212. In this way, it can be ensured to the maximum extent that the light beam output by the second display device 212 is incident on the second lens 242 along the normal line, and the reflection and refraction of the light beam output by the second display device 212 when entering the second lens 242 are avoided to the maximum extent, which is further conducive to improving the projection effect.

The curvature of the light entrance surface 433 of the third lens 243 is equal to the curvature of the display surface 233 of the third display device 213. In this way, it can be ensured to the maximum extent that the light beam output by the third display device 213 is incident on the third lens 243 along the normal line, and the reflection and refraction of the light beam output by the third display device 213 when entering the third lens 243 are avoided to the maximum extent, which is further conducive to improving the projection effect.

In the above examples, the curvature of the display surface 231 of the first display device 211, the curvature of the display surface 232 of the second display device 212, and the curvature of the display surface 233 of the third display device 213 are equal. In this example, the curvature of the light entrance surface 431 of the first lens 241, the curvature of the light entrance surface 432 of the second lens 242, and the curvature of the light entrance surface 433 of the third lens 243 are also equal.

In an alternative example, the light entrance surface of the projection lens assembly can also be a plane, that is, the light entrance surfaces of the first lens 241, the second lens 242, and the third lens 243 are planes. Specifically, the light entrance surface 431 of the first lens 241 is a plane, the light entrance surface 432 of the second lens 242 is a plane, and the light entrance surface 433 of the third lens 243 is a plane. Taking the light entrance surface 431 of the first lens 241 as a plane as an example, as shown in FIG. 9. Optionally, the first lens 241, the second lens 242, and the third lens 243 can all be set in a prismatic column shape, and the light entrance surfaces of the first lens 241, the second lens 242, and the third lens 243 are all planes, so that the light entrance surface of the projection lens assembly is set in a multi-plane splicing shape. Optionally, the first lens 241, the second lens 242, and the third lens 243 can be spliced together to form at least part of a quadrangular prism.

It should be noted that, since the display surface of the display device in this application example is designed as a curved surface (for example, FIG. 9 shows that the display surface 231 of the first display device 211 is a curved surface), and its curvature matches the curvature of the projection surface of the projection screen, it can already improve the consistency of the projection imaging clarity to a certain extent, and can help ensure that different parts of the projection imaging are focused clearly at the same time. It can be seen that the design of the light entrance surface of the above-mentioned projection lens assembly is a plane, which also conforms to the design idea of this application example.

In other examples of this application, the light entrance surface of the projection lens assembly can be partially curved and partially flat. Specifically, some of the lenses from the first lens 241, the second lens 242, and the third lens 243 have a curved light entrance surface, and some have a flat light entrance surface, which is not limited here.

In one example, the first display device 211 is located between the plane where the first side surface 421 of the first lens 241 is located and the plane where the second side surface 441 of the first lens 241 is located. In other words, the first display device 211 is located between the extension plane of the first side surface 421 of the first lens 241 and the extension plane of the second side surface 441 of the first lens 241. In this way, the light beam output by the first display device 211 can all be incident on the first lens 241, which is further conducive to improving the projection effect.

The second display device 212 is located between the plane where the first side surface 422 of the second lens 242 is located and the plane where the second side surface 442 of the second lens 242 is located. In other words, the second display device 212 is located between the extension plane of the first side surface 422 of the second lens 242 and the extension plane of the second side surface 442 of the second lens 242. In this way, the light beam output by the second display device 212 can all be incident on the second lens 242, which is further conducive to improving the projection effect.

The third display device 213 is located between the plane where the first side surface 423 of the third lens 243 is located and the plane where the second side surface 443 of the third lens 243 is located. In other words, the third display device 213 is located between the extension plane of the first side surface 423 of the third lens 243 and the extension plane of the second side surface 443 of the third lens 243. In this way, the light beam output by the third display device 213 can all be incident on the third lens 243, which is further conducive to improving the projection effect.

Please refer to FIG. 4. In one example, the first display device 211 and the first lens 241 are spaced apart, the second display device 212 and the second lens 242 are spaced apart, and the third display device 213 and the third lens 243 are spaced apart, forming an adjustable gap D. In this way, the display device and the corresponding lens are set apart from each other, making the adjustment of the relative position between the display device and the lens more flexible, avoiding the design requirements for the processing precision of the display device and the lens fitting setting, and facilitating the assembly and production process of the projection device. For example, the adjustable gap D will affect the design of the back focal length (BFD) of the projection system. According to the product's demand for the back focal length, the size of the adjustable gap D can be adjusted correspondingly, so that the back focal length of the projection system meets the requirements.

Please refer to FIGS. 2, 4, and 6. In one example, the projection lens assembly also comprises a light-adjusting lens group 25. The light beam integrated by the color-combining lens group 24 is incident on the light-adjusting lens group 25, and then is emitted from the light-adjusting lens group 25. The first lens 241, the second lens 242, and the third lens 243 and the light-adjusting lens group 25 are set in the above-mentioned circular direction in sequence, and the light beams incident on the first lens 241, the second lens 242, and the third lens 243 all emit from the light-adjusting lens group 25.

In one example, the light-adjusting lens group 25 comprises a curved mirror, which protrudes towards the direction of light propagation. Specifically, the light-adjusting lens group 25 comprises a fourth lens 251, which is the curved mirror. The first lens 241, the second lens 242, the third lens 243, and the fourth lens 251 are arranged in sequence along the aforementioned circular direction. The fourth lens 251 is also a prismatic body, and the target edges 411 of the first lens 241, the target edges 412 of the second lens 242, the target edges 413 of the third lens 243, and the target edges 414 of the fourth lens 251 coincide.

In another example, the fourth lens 251 can be a curved mirror of a sheet structure, protruding towards the direction of light emission. At this time, there is a light mixing space between the fourth lens 251 and the first lens 241, the second lens 242, and the third lens 243. The light is emitted from the first lens 241, the second lens 242, and the third lens 243 and then enters the fourth lens 251 through the light mixing space.

For example, taking the first and second side surfaces of the above-mentioned prismatic body arranged in sequence along the circular direction as an example, the second side surface 444 of the fourth lens 251 and the first side surface 421 of the first lens 241 are close to each other, and the first side surface 424 of the fourth lens 251 and the second side surface 443 of the third lens 243 are close to each other, as shown in FIG. 4. Moreover, the heights of the first lens 241, the second lens 242, the third lens 243, and the fourth lens 251 are the same, the top surfaces of the four are on the same plane, and the bottom surfaces of the four are also on the same plane, as shown in FIG. 6.

The fourth lens 251 is located on the side of the first lens 241 and the third lens 243 away from the second lens 242, and a first film layer 245 is provided between the third lens 243 and the fourth lens 251, and a second film layer 246 is provided between the first lens 241 and the fourth lens 251. The fourth lens 251 is used to integrate the light beams output by the first display device 211, the second display device 212, and the third display device 213 and project them onto the projection lens assembly. In other words, the light beams projected by the first display device 211 through the first lens 241, the light beams projected by the second display device 212 through the second lens 242, and the light beams projected by the third display device 213 through the third lens 243 converge at the fourth lens 251, integrating the light beams output by the first display device 211, the second display device 212, and the third display device 213 together.

As shown in FIG. 7, the light beam output by the first display device 211 is incident on the first lens 241, and is reflected in the first film layer 245, then enters the fourth lens 251, and finally emits from the fourth lens 251. The light beam output by the second display device 212 is incident on the second lens 242, and directly passes through the first film layer 245 and the second film layer 246, then enters the fourth lens 251, and finally emits from the fourth lens 251. The light beam output by the third display device 213 is incident on the third lens 243, and is reflected in the second film layer 246, then enters the fourth lens 251, and finally emits from the fourth lens 251.

The fourth lens 251 participates in the design of the back focal length of the projection device 20, and the material selection of the fourth lens 251 and the curvature of the light entrance surface 434 of the fourth lens 251 will all affect the overall back focal length of the projection device 20. In this example, the curvature of the light entrance surface 434 of the fourth lens 251 can be different from the first lens 241, the second lens 242, and the third lens 243. The curvature of the light entrance surface 434 of the fourth lens 251 can match the design of the optical system of the entire projection device 20, for example, the curvature of the light entrance surface 434 of the fourth lens 251 matches the design of the focal length of the projection lens assembly, which can make the light utilization rate of the entire optical system higher and the light effect better. Other lenses can also be added between the fourth lens 251 and the projection lens assembly to further improve the light utilization rate of the entire optical system and improve the light effect, which is not limited here.

In other examples of this application, the curvature of the light entrance surface 434 of the fourth lens 251 can also be the same as that of the first lens 241, the second lens 242, and the third lens 243. Especially for the case where the curvature of the light entrance surface 431 of the first lens 241, the curvature of the light entrance surface 432 of the second lens 242, and the curvature of the light entrance surface 433 of the third lens 243 are equal in the above examples, the cross-sections of the first lens 241, the second lens 242, the third lens 243, and the fourth lens 251 along their respective height directions are all fan-shaped, and the first lens 241, the second lens 242, the third lens 243, and the fourth lens 251 form a complete cylinder. Moreover, the projection lens assembly of this application example can also not design the fourth lens 251, but only comprises the first lens 241, the second lens 242, and the third lens 243 as explained in the above example.

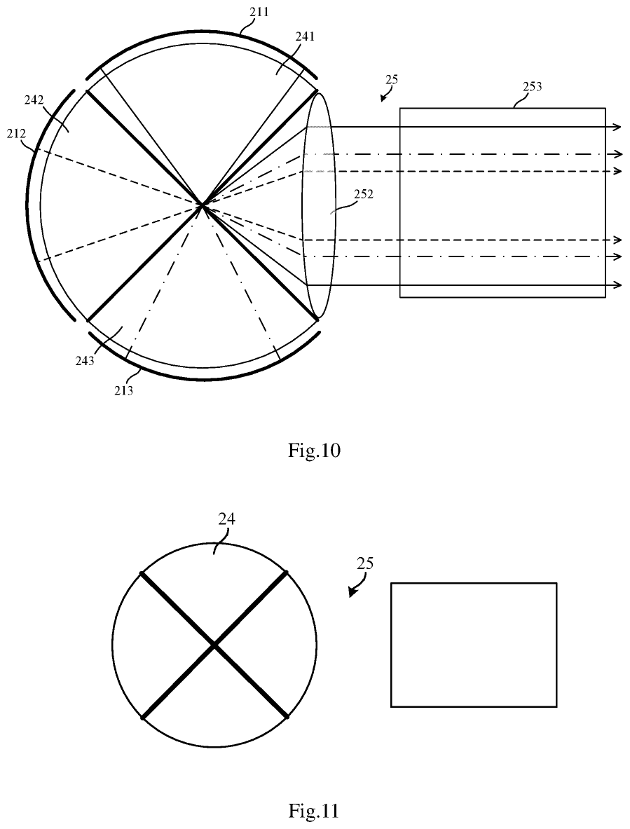

In an alternative example, please refer to FIG. 10, the difference from the above example is that in this example, the light-adjusting lens group 25 can be several light-adjusting lenses, which are arranged in sequence along the direction of light propagation. Specifically, the several light-adjusting lenses comprise a fifth lens 252 and a sixth lens 253, which are arranged in sequence along the direction of light propagation.

The light beam output from the first display device 211 to the first lens 241 is transmitted to the fifth lens 252; the light beam output from the second display device 212 to the second lens 242 is transmitted to the fifth lens 252; the light beam output from the third display device 213 to the third lens 243 is transmitted to the fifth lens 252. Moreover, the light beams transmitted from the first display device 211 to the third display device 213 to the fifth lens 252 are integrated at the fifth lens 252, and the integrated light beam is transmitted to the sixth lens 253, and projected onto the projection screen through the sixth lens 253.

Through the above method, the design of the fifth lens 252 and the sixth lens 253 can further improve the light utilization rate of the entire projection system and improve the light effect. Of course, the several dimming lenses included in the dimming lens group 25 of this example are not limited to the above-mentioned fifth lens 252 and sixth lens 253, and are not limited here.

In summary, the projection device provided by this application has a curved display surface of the display device. The clear image projected by the display device through the projection lens component is a curved image. Moreover, when the projection surface of the projection screen is also curved, the curvature of the display surface matches the curvature of the projection surface, so that the curvature of the clear image projected by the display device matches the curvature of the projection surface, thereby enabling the clear image projected by the display device to be displayed on the projection surface as completely as possible. That is, the middle and both sides of the projection surface can focus clearly at the same time, the middle and both sides of the image projected on the projection surface can be clearly imaged, that is, the image projected on the projection surface is clearer and the overall clarity is more consistent, which can improve the projection effect and is beneficial to improve the user's viewing experience.

Please refer to FIG. 11, which is a schematic diagram of the structure of an example of the projection lens component of this application.

In one example, the projection lens component is applied to the projection device described in the above example. The projection lens component comprises a color combining lens group 24 and a dimming lens group 25. The light beam integrated by the color combining lens group 24 is incident on the dimming lens group 25, and then emitted by the dimming lens group 25. The projection lens component has been described in detail in the above examples, so it will not be repeated here.

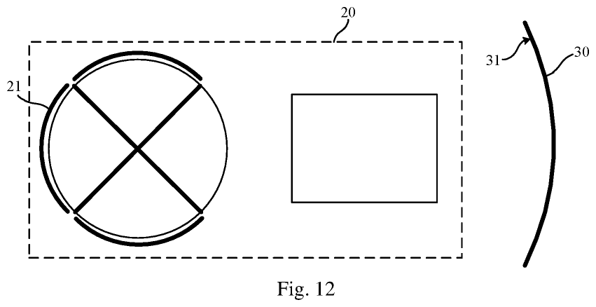

Please refer to FIG. 12, which is a schematic diagram of the structure of another example of the projection system of this application.

In one example, the projection system comprises a projection device 20 and a projection screen 30. The projection device 20 can be as described in the above example. The projection screen 30 has a projection surface 31, and the light beam output by the display device 21 of the projection device 20 is projected onto the projection surface 31 through the projection lens component.

In addition, in this application, unless otherwise explicitly specified and limited, terms such as “connected”, “connected”, “stacked”, etc. should be broadly understood, for example, it can be a fixed connection, or it can be a detachable connection, or integrated; it can be directly connected, or indirectly connected through an intermediate medium, it can be the communication within two components or the interaction between two components. For those skilled in the art, the specific meaning of the above terms in this application can be understood according to specific circumstances.

Finally, it should be noted that: the above examples are only used to illustrate the technical solution of this application, and not to limit it; although the technical solution of this application has been described in detail with reference to the above examples, those skilled in the art should understand: they can still modify the technical solutions recorded in the above examples, or replace some or all of the technical features equivalently; and these modifications or replacements do not make the essence of the corresponding technical solution depart from the scope of the technical solution of each example of this application.

1. A projection device comprising:
a display device, having a curved display surface, wherein a curvature of the curved display surface matches a curvature of a projection surface of a projection screen; and
a projection lens component, wherein an incident light surface of the projection lens component is a convex arc surface towards the curved display surface.

2. The projection device according to claim 1, wherein:
the display device comprises a first display device, a second display device, and a third display device, and each of the first display device, the second display device, and the third display device outputs an image of a different color,
the projection lens component comprises a first lens, a second lens, and a third lens,
the first lens, the second lens, and the third lens are arranged in a circular direction in sequence,
an incident light surface of the first lens corresponds to the first display device,
an incident light surface of the second lens corresponds to the second display device, and
an incident light surface of the third lens corresponds to the third display device.

3. The projection device according to claim 2, further comprising:
a first film layer provided on a surface between the first lens and the second lens, wherein the first film layer is configured to reflect a light beam output by the first display device and transmit a light beam output by the second display device and the third display device; and
a second film layer provided on a surface between the second lens and the third lens, the second film layer is configured to reflect a light beam output by the third display device and transmit a light beam output by the first display device and the second display device.

4. The projection device according to claim 2, wherein a curvature of a display surface of the first display device, a curvature of a display surface of the second display device, and a curvature of a display surface of the third display device are equal.

5. The projection device according to claim 2, wherein:
the incident light surface of the first lens is a curved surface convex towards the first display device;
the incident light surface of the second lens is a curved surface convex towards the second display device; and
the incident light surface of the third lens is a curved surface convex towards the third display device.

6. The projection device according to claim 2, wherein:
a curvature of the incident light surface of the first lens is equal to a curvature of a display surface of the first display device;
a curvature of the incident light surface of the second lens is equal to a curvature of a display surface of the second display device; and
a curvature of the incident light surface of the third lens is equal to a curvature of a display surface of the third display device.

7. The projection device according to claim 2, wherein each of the incident light of the first lens, the incident light surface of the second lens, and the incident light surface of the third lens.

8. The projection device according to claim 2, wherein the first display device is spaced from the first lens, the second display device is spaced from the second lens, and the third display device is spaced from the third lens.

9. The projection device according to claim 2, wherein:
the projection lens component further comprises a light-adjusting lens group,
the first lens, the second lens, the third lens, and the light-adjusting lens group are arranged in a circular direction in sequence, and
incident light beams on the first lens, the second lens, or the third lens are emitted from the light-adjusting lens group.

10. The projection device according to claim 9, wherein the light-adjusting lens group comprises a plurality of light-adjusting lenses, the plurality of light-adjusting lenses are arranged in sequence along the direction of light beam propagation.

11. A projection device comprising:
a projection screen;
a display device, having a curved display surface, wherein a curvature of the curved display surface matches a curvature of a projection surface of the projection screen; and
a projection lens component set between the display device and the projection surface of the projection screen, wherein the projection lens component has an incident light surface; and
wherein the curved display surface of the display device is surrounded by a part of an outer periphery of the incident light surface of the projection lens component, and the projection lens component is configured to guide a light beam emitted from the curved display surface from the part of the outer periphery surrounded by the incident light surface to another part of the outer periphery of the incident light surface, and project the light beam to the projection surface.

12. The projection device according to claim 11, wherein:
the display device comprises a first display device, a second display device, and a third display device, and each of the first display device, the second display device, and the third display device outputs an image of a different color,
the projection lens component comprises a first lens, second lens, and a third lens,
the first lens, the second lens, and the third lens are arranged in a circular direction in sequence,
an incident light surface of the first lens corresponds to the first display device,
an incident light surface of the second lens corresponds to the second display device, and
an incident light surface of the third lens corresponds to the third display device.

13. The projection device according to claim 12, wherein:
the incident light surface of the projection lens component is set in an arc shape and convex towards the display surface;
the first lens, the second lens, and the third lens are in a fan-shaped cylindrical shape, and the incident light surfaces of the first lens, the second lens, and the third lens are all set in an arc shape;
a curvature of the incident light surface of the first lens is equal to a curvature of a display surface of the first display device;
a curvature of the incident light surface of the second lens is equal to a curvature of a display surface of the second display device; and
a curvature of the incident light surface of the third lens is equal to a curvature of a display surface of the third display device.

14. The projection device according to claim 13, wherein:
the first lens, the second lens, and the third lens are spliced together to form at least a part of a cylinder, and the projection device further comprises:
a first film layer provided on the surface between the first lens and the second lens, wherein the first film layer is configured to reflect a light beam output by the first display device and transmit a light beam output by the second display device and the third display device; and
a second film layer provided on a surface between the second lens and the third lens, the second film layer is configured to reflect a light beam output by the third display device and transmit a light beam output by the first display device and the second display device.

15. The projection device according to claim 12, wherein:
the incident light surface of the projection lens component is in a flat shape,
the first lens, the second lens, and the third lens are in a rhombic column shape, and
the incident light surfaces of the first lens, the second lens, and the third lens are flat, so that the incident light surface of the projection lens component is set in a multi-flat splicing shape.

16. The projection device according to claim 15, wherein:
the first lens, the second lens, and the third lens are spliced together to form at least a part of a quadrangular prism, and the projection device further comprises:
a first film layer provided on the surface between the first lens and the second lens, wherein the first film layer is configured to reflect a light beam output by the first display device and transmit a light beam output by the second display device and the third display device; and
a second film layer provided on a surface between the second lens and the third lens, the second film layer is configured to reflect a light beam output by the third display device and transmit a light beam output by the first display device and the second display device.

17. The projection device according to claim 12, wherein:
the first display device is spaced from the first lens,
the second display device is spaced from the second lens, and
the third display device is spaced from the third lens.

18. The projection device according to claim 12, wherein:
the projection lens component further comprises a light-adjusting lens group,
the first lens, the second lens, and the third lens and the light-adjusting lens group are arranged in the circular direction in sequence, and
the light beams incident on the the first lens, the second lens, and the third lens are emitted from the light-adjusting lens group.

19. The projection device according to claim 18, wherein:
the light-adjusting lens group comprises several light-adjusting lenses,
the several light-adjusting lenses are arranged in sequence along a direction of light beam propagation, or
the light-adjusting lens group comprises an arc mirror, and the arc mirror is convex towards the direction of light beam propagation.

20. A projection system comprises:
a projection device, and
a projection screen comprising a projection surface,
wherein the projection device comprises:
a display device, having a curved display surface, wherein a curvature of the curved display surface matches a curvature of the projection surface; and
a projection lens component, wherein an incident light surface of the projection lens component is a convex arc surface towards the curved display surface, and a light beam output by the curved display surface is projected onto the projection surface through the projection lens component.
